(19) United States
(12) Patent Application Publication
(10) Pub. No.: US 2009/0170004 A1
(43) Pub. Date: Jul. 2, 2009

(54) ELECTRODE FOR RECHARGEABLE BATTERY AND METHOD FOR MANUFACTURING THE SAME

(75) Inventors: Takashi Okawa, Kanagawa (JP); Takashi Ebihara, Kanagawa (JP); Yoshinori Ito, Kanagawa (JP)

Correspondence Address: MCDERMOTT WILL & EMERY LLP, 600 13TH STREET, NW, WASHINGTON, DC, 20005-3096, US

(73) Assignee: PANASONIC CORPORATION, OSAKA (JP)

(21) Appl. No.: 12/300,441

(22) PCT Filed: Apr. 25, 2007
(86) PCT No.: PCT/JP2007/058971

§ 371 Date: Nov. 11, 2008

(51) Int. Cl. H01M 4/70; B05D 5/12

(52) U.S. Cl. 429/233; 427/77

(57) ABSTRACT

A rechargeable battery electrode of the present invention is produced by filling voids in a three-dimensional metal porous body (1) with an active material (2). A metal-rich layer (3) having a metal density greater than other portions is provided in a region except for thicknesswise surface layer portions of the three-dimensional metal porous body. The metal-rich layer is allowed to be responsible for current collecting characteristics, and the configuration thereof is optimized. In this manner, a rechargeable battery electrode excellent in both short circuit resistance and current collecting characteristics is achieved.

### TECHNICAL FIELD

The present invention relates to an electrode for a rechargeable battery that is used for an alkaline rechargeable battery and the like and to a method for manufacturing the electrode. In particular, the invention relates to a technique for improving the current collecting characteristics of the electrode and suppressing the occurrence of a short circuit at the time of winding.

### BACKGROUND ART

Rechargeable batteries, particularly alkaline rechargeable batteries, have a sufficient capacity density and can withstand overcharge and irregular charge-discharge cycles, and therefore the range of their applications, including tough-use applications, is growing.

The electrodes for alkaline rechargeable batteries are broadly categorized into paste-type electrodes and sintered-type electrodes. In recent years, with a view to increasing capacity, paste-type electrodes are used as the positive electrodes of alkaline rechargeable batteries. The paste-type electrode is produced by filling voids in a three-dimensional metal porous body, such as a sponge-like metal porous material or a nickel fiber nonwoven fabric, with a paste containing an active material as a main component.

Such a three-dimensional metal porous body has a porosity (the ratio of the volume of voids to the total volume) of about 95%, and the maximum pore diameter of the voids is as large as hundreds of μm. Therefore, a large amount of the paste can be directly charged into the porous body. However, if a larger amount of the paste is charged by unintentionally increasing the porosity in order to obtain a high capacity paste-type electrode, the ratio of metal in a portion filled with the paste is excessively low, so that the current collecting characteristics deteriorate. This results in a reduction in the discharge characteristics of the rechargeable battery.

To address the above problems, techniques for improving the discharge characteristics of rechargeable batteries have been proposed. Specifically, the discharge characteristics are improved by using an electrode structure in which an active material is charged only into one side of a three-dimensional metal porous body in its thickness direction. In this structure, the other side unfilled with the active material is responsible for collecting a current. Such an electrode structure is achieved by properly designing the structure of the three-dimensional metal porous body (see Patent Document 1) or using a properly devised method for charging a paste (see Patent Document 2). FIG. 2 is a schematic cross-sectional view of such an electrode for a rechargeable battery.

[Patent Document 1] Japanese Patent Application Laid-Open No. 2000-208144.

[Patent Document 2] Japanese Patent No. 2976863.

### DISCLOSURE OF THE INVENTION

### Problems to be Solved by the Invention

When a paste-type electrode formed using a three-dimensional metal porous body is wound together with a counter electrode and a separator into a spiral shape and is contained in a cylindrical case, a crack tends to occur at a high curvature portion around a winding core. In the electrode produced using the technique described in Patent Document 1 or 2, a region 30 in which the ratio of metal present therein is high (hereinafter referred to as a metal-rich layer) is distributed only near one surface of a three-dimensional metal porous body 10, as shown in FIG. 2. The metal-rich layer 30 itself is more flexible under stress than the portion filled with the active material and is therefore durable against bending, so that a crack due to winding is less likely to occur. However, the metal skeleton is present irregularly and discontinuously at the surface of the three-dimensional metal porous body. Therefore, at the time of winding, the discontinuous portions of the metal skeleton in the metal-rich layer may protrude from the surface of the electrode and may break the separator, and therefore an internal short circuit due to contact with the counter electrode tends to occur. A large number of the discontinuous portions of the metal skeleton are present particularly at the end faces of the electrode since the end faces are formed by cutting. Therefore, an internal short circuit is more likely to occur at the end faces.

The present invention has been made in view of the above problems, and it is an object of the invention to provide an electrode for a rechargeable battery that is excellent in both short circuit resistance and current collecting characteristics. The electrode is formed by optimizing the configuration of a metal-rich layer that is allowed to be responsible for the current collecting characteristics of the electrode.

### Means for Solving the Problems

To achieve the above object, the present invention provides an electrode for a rechargeable battery, including a three-dimensional metal porous body and an active material charged into voids in the three-dimensional metal porous body, wherein the three-dimensional metal porous body includes a metal-rich layer having a metal density greater than that of the rest of the three-dimensional metal porous body, the metal-rich layer being provided in a region except for a thicknesswise surface layer portion of the three-dimensional metal porous body.

To obtain the above rechargeable battery electrode, the present invention provides a method for manufacturing a rechargeable battery electrode in which a paste containing an active material as a main component is charged into voids in a strip-like three-dimensional metal porous body while the three-dimensional metal porous body is moved. The method includes: a first step of producing an electrode precursor by ejecting the paste from a pair of paste-ejecting nozzles disposed so as to face opposite surfaces of the three-dimensional metal porous body, the paste being ejected such that a portion unfilled with the paste is left inside the three-dimensional metal porous body; a second step of drying the electrode precursor; and a third step of rolling the dried electrode precursor.

In the rechargeable battery electrode of the present invention manufactured as above, the metal-rich layer including a discontinuous metal skeleton is not located in the surface layer portions of the electrode. Therefore, an internal short circuit is prevented which is caused by contact between the discontinuous metal skeleton in the metal-rich layer and the counter electrode when the discontinuous metal skeleton protrudes from the surface of the electrode and breaks the separator at the time of winding.

In the present invention, the metal-rich layer responsible for current collecting characteristics can be properly disposed. Therefore, a rechargeable battery electrode excellent in both short circuit resistance and current collecting characteristics and a high-performance rechargeable battery using this electrode can be provided.

### BRIEF DESCRIPTION OF THE DRAWINGS

FIG. 1 is a schematic cross-sectional view of a rechargeable battery electrode of one embodiment of the present invention.

FIG. 2 is a schematic cross-sectional view of a conventional rechargeable battery electrode.

FIG. 3 is a schematic cross-sectional view of a rechargeable battery electrode of another embodiment of the present invention.

FIG. 4 is a schematic cross-sectional view illustrating a first step in a rechargeable battery electrode manufacturing method of the present invention.

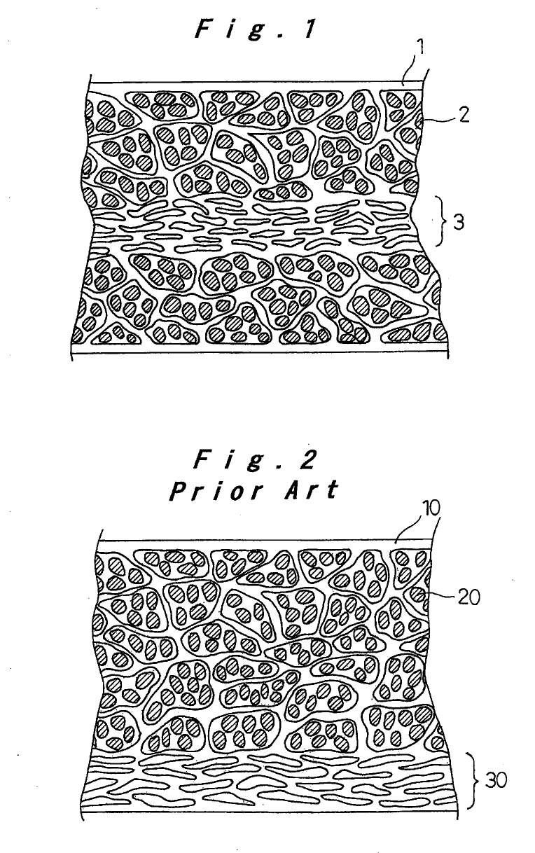

### BEST MODE FOR CARRYING OUT THE INVENTION

The best mode for carrying out the invention will be described in detail with reference to the drawings.

A rechargeable battery electrode according to the present invention is produced by filling voids in a three-dimensional metal porous body with an active material, and a metal-rich layer having a metal density greater than that of other portions is provided in a region except for the thicknesswise surface layer portions of the three-dimensional metal porous body.

FIG. 1 is a schematic cross-sectional view illustrating a rechargeable battery electrode of one embodiment of the present invention. The electrode is produced by filling voids in a three-dimensional metal porous body 1 with an active material 2, and a metal-rich layer 3 having a metal density greater than that of other portions is provided in a region except for the surface layer portions of the three-dimensional metal porous body 1.

In the rechargeable battery electrode of the present invention, the metal-rich layer 3 is not located at the surface layer portions of the electrode. Therefore, the fear of an internal short circuit caused when a discontinuous metal skeleton in the metal-rich layer protrudes from the surface of the electrode at the time of winding can be eliminated. Cracks may occur in the portions filled with the active material 2 because these portions are less durable against bending than the metal-rich layer 3. However, since the cracks do not grow beyond the metal-rich layer 3, the durability of the electrode as a whole against bending can be improved. Therefore, an electrode with high short circuit resistance can be achieved.

A sponge-like metal porous body, a fiber nonwoven fabric, or the like which can be made of nickel or nickel-coated iron may be used as the three-dimensional metal porous body 1. For positive electrodes for alkaline rechargeable batteries, nickel hydroxide powder can be used as the active material 2. For negative electrodes for alkaline rechargeable batteries, hydrogen absorption alloy powder can be used as the active material 2. When nickel hydroxide powder is used as the active material 2, it is preferable to use a conductive agent such as cobalt hydroxide or metallic cobalt, a binding agent such as polytetrafluoroethylene (hereinafter abbreviated as PTFE), and a thickening agent such as carboxymethyl cellulose (hereinafter abbreviated as CMC) together with the nickel hydroxide powder.

In the three-dimensional metal porous body 1 described above, the ratio of the thickness of the metal-rich layer 3 to the thickness of the electrode is preferably 5 to 15%. When the ratio of the thickness of the metal-rich layer 3 to the thickness of the electrode is less than 5%, it is difficult to impart to the metal-rich layer 3 the above effect of preventing an internal short circuit and the effect of improving the durability against bending. Meanwhile, to ensure the capacity of the battery, the areal metal weight (the weight of metal per unit area) in the three-dimensional metal porous body 1 must be held constant. However, to increase the ratio of the thickness of the metal-rich layer 3 to more than 15% while the above condition is satisfied, the thickness of the three-dimensional metal porous body 1 must first be increased. Therefore, the thickness of the metal skeleton in the portions filled with the active material 2 is reduced, and this causes cracks to occur during winding, so that the probability of causing an internal short circuit rather increases.

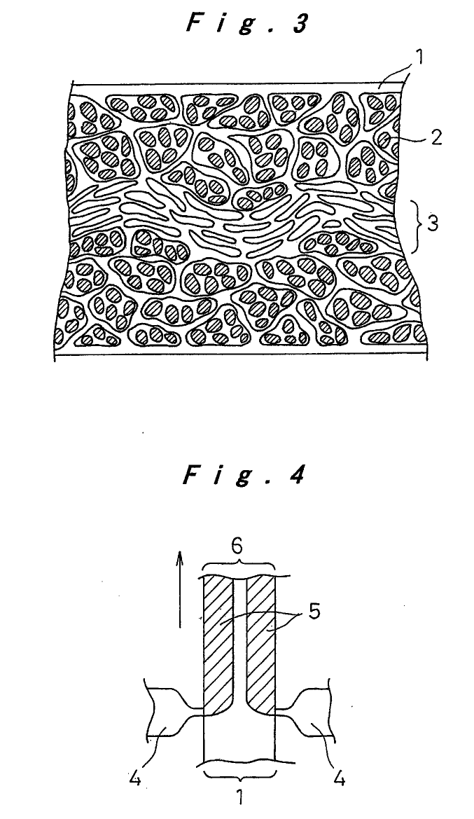

Moreover, in the three-dimensional metal porous body 1, the position of the metal-rich layer 3 may be periodically changed in the thickness direction of the electrode. FIG. 3 is a schematic cross-sectional view of a rechargeable battery electrode having such a structure. The position of the metal-rich layer 3 is periodically changed in the thickness direction of the electrode. Since the position of the metal-rich layer 3 is periodically changed, a bellows-like structure is formed. This structure is preferable since the stress caused by the metal-rich layer 3 stretched during winding is relaxed. In addition, when the above electrode is wound, cracks tend to occur in areas in which the distance between the metal-rich layer 3 and the surface layer on the outer side at the time of winging is largest. However, the spacings between the cracks are larger relative to those in an electrode in which the position of the metal-rich layer 3 is not changed. Accordingly, the number of occurrence of cracks can be reduced, and the short circuit resistance can be further improved.

A method for manufacturing a rechargeable battery electrode according to the present invention is a method in which a paste containing an active material as a main component is charged into voids in a strip-like three-dimensional metal porous body while the three-dimensional metal porous body is moved. The method is characterized by including: a first step of producing an electrode precursor by ejecting the paste from a pair of paste-ejecting nozzles disposed so as to face opposite surfaces of the three-dimensional metal porous body, the paste being ejected such that a portion unfilled with the paste is left inside the three-dimensional metal porous body; a second step of drying the electrode precursor; and a third step of rolling the dried electrode precursor.

FIG. 4 is a schematic cross-sectional view illustrating the first step in the method for manufacturing the rechargeable battery electrode according to the present invention. The pair of paste-ejecting nozzles 4 are disposed so as to face the opposite surfaces of the strip-like three-dimensional metal porous body 1 moving from the lower side to the upper side in FIG. 4, and the paste 5 containing the active material 2 as a main component is ejected from the paste-ejecting nozzles 4, whereby the electrode precursor 6 is produced. In this case, the amount of the ejected paste 5 is controlled such that a portion unfilled with the paste 5 is left inside the three-dimensional metal porous body 1. In this manner, the electrode precursor 6 subjected to the second and third steps (not shown) can be used as the rechargeable battery electrode according to the present invention.

In the above method for manufacturing the rechargeable battery electrode, while the total amount of the paste 5 ejected from the pair of paste-ejecting nozzles 4 is maintained substantially constant in the first step, the amount of the paste ejected from one of the paste-ejecting nozzles 4 and the amount of the paste ejected from the other paste-ejecting nozzle 4 may be periodically changed. With such a method, the electrode precursor 6 subjected to the second and third steps can be used as a rechargeable battery electrode in which the position of the metal-rich layer 3 is periodically changed in the thickness direction of the electrode.

Hereinafter, the present invention will be described in more detail by way of Examples.

### Example 1

A pair of paste-ejecting nozzles 4 were disposed so as to face the opposite surfaces of a three-dimensional metal porous body 1 (thickness: 2.0 mm, areal metal weight: 700 g/cm³) moving at 5 m/min. A paste 5 was prepared by adding 10 parts by weight of cobalt hydroxide, 0.5 parts by weight of PTFE, 0.3 parts by weight of CMC, and an appropriate amount of water to 100 parts by weight of nickel hydroxide powder (average particle size: 10 μm) serving as the active material 2. The paste 5 (solids content: 70%) was ejected while a constant pressure was applied using a pump. In this manner, the three-dimensional metal porous body 1 was filled with the paste 5 to a depth of 0.5 mm from each surface layer, whereby an electrode precursor 6 was produced. The obtained electrode precursor 6 was dried and then rolled to a thickness of 0.68 mm, whereby a metal-rich layer 3 (thickness: 0.10 mm, ratio of this thickness to the thickness of the electrode: 15%) having a large metal density was formed in a central portion in the thickness direction. The rolled electrode precursor 6 was machined to a vertical dimension of 35 mm and a horizontal dimension of 250 mm, and a lead plate was attached thereto, whereby a positive electrode was produced. This positive electrode was used as the electrode of Example 1.

### Example 2

A positive electrode similar to that of Example 1 was produced except that the thickness of the three-dimensional metal porous body 1 was changed to 1.2 mm, that the electrode precursor 6 after drying was rolled to a thickness of 0.61 mm, and that the thickness of the metal-rich layer 3 was changed to 0.03 mm (ratio of this thickness to the thickness of the electrode: 5%). This electrode was used as the electrode of Example 2.

### Example 3

The total amount of the paste 5 ejected from the pair of paste-ejecting nozzles 4 was adjusted to a constant value such that the three-dimensional metal porous body 1 was filled with the paste 5 to a depth of 1.0 mm in the thickness direction. In addition, the amount of the paste 5 ejected from one of the paste-ejecting nozzles 4 and the amount of the paste 5 ejected from the other paste-ejecting nozzle 4 were periodically changed. Specifically, each time when the three-dimensional metal porous body 1 was moved 10 mm, the depth of the three-dimensional metal porous body 1 filled with the paste 5 was periodically changed from 0.30 to 0.70 mm from each surface layer. A positive electrode produced in the same manner as in Example 1 except for the above procedure was used as the electrode of Example 3. The ratio of the thickness of the metal-rich layer 3 to the thickness of the electrode was 15%, which is the same as that in Example 1.

### Example 4

A positive electrode similar to that of Example 1 was produced except that the thickness of the three-dimensional metal porous body 1 was changed to 3.5 mm, that the electrode precursor 6 after drying was rolled to a thickness of 0.73 mm, and that the thickness of the metal-rich layer 3 was changed to 0.15 mm (ratio of this thickness to the thickness of the electrode: 20%). This electrode was used as the electrode of Example 4.

### Example 5

A positive electrode similar to that of Example 1 was produced except that the thickness of the three-dimensional metal porous body 1 was changed to 1.1 mm, that the electrode precursor 6 after drying was rolled to a thickness of 0.60 mm, and that the thickness of the metal-rich layer 3 was changed to 0.02 mm (ratio of this thickness to the thickness of the electrode: 3%). This electrode was used as the electrode of Example 5.

### Comparative Example 1

A positive electrode similar to that of Example 1 was produced except that the thickness of the three-dimensional metal porous body 1 was changed to 1.0 mm, that the electrode precursor 6 after drying was rolled to a thickness of 0.58 mm, and that the metal-rich layer 3 was not formed. This electrode was used as the electrode of Comparative Example 1.

### Comparative Example 2

The paste 5 was ejected from only one of the paste-ejecting nozzles 4 to fill the three-dimensional metal porous body 1 with the paste 5 to a depth of 1.0 mm from one surface layer, whereby an electrode precursor 6 was produced. The produced electrode precursor 6 was dried and then rolled to a thickness of 0.61 mm. In this manner, a metal-rich layer 3 (thickness: 0.03 mm, ratio of this thickness to the thickness of the electrode: 5%) was formed only in one of the surface layers of the electrode. A positive electrode produced in the same manner as in Example 2 except for the above procedure was used as the electrode of Comparative Example 2.

Each of the obtained positive electrodes of the Examples and Comparative Examples and a negative electrode produced using a known MmNi5-based hydrogen absorption alloy (thickness: 0.5 mm, vertical dimension: 35 mm, horizontal dimension 300 mm, Mn is a mixture of light rare earth elements) were stacked with a hydrophilic-treated polypropylene non-woven fabric separator (thickness: 0.15 mm, vertical dimension: 39 mm, horizontal dimension 550 mm) interposed therebetween. The stacked body was wound into a spiral shape to form an electrode plate assembly.

Cracks formed in each electrode plate assembly were evaluated by computing the percentage of the maximum value of the depths of the cracks measured in the thickness direction of the positive electrode on the bottom surface of the cylindrical electrode plate assembly. Thousand pieces of each electrode plate assembly were produced and evaluated for insulation properties. Specifically, if the resistance was 2 kΩ or greater when a voltage of 150 V was applied, the electrode plate assembly was evaluated as “pass,” and the ratio of internally short-circuited electrode plate assemblies was determined. Moreover, ten pieces of each electrode plate assembly were inserted into cylindrical cases. A 30 wt % aqueous solution of potassium hydroxide serving as an electrolyte was charged into each case, and the case was sealed with a sealing plate, whereby cylindrical nickel metal hydride batteries with a theoretical capacity of 3,000 mAh were obtained. Each battery was charged and discharged using a one hour rate (1 It) current, and the average discharge capacity and the representative value of the average discharge voltages (the fifth largest value) were determined. All of the results are shown in Table 1.

TABLE 1

| | Ratio of | Position of | | | | |
|---|---|---|---|---|---|---|
| | thickness | metal-rich layer | Maximum | occurrence of | 1It discharge | 1It average |
| | of metal-rich | in thickness | depth of | internal short | capacity | discharge |
| | layer (%) | direction | cracks (%) | circuits (%) | (mAh) | voltage (V) |
| Example 1 | 15% | Center | 25 | 0.3% | 2835 | 1.197 |
| Example 2 | 5% | Center | 36 | 0.6% | 2805 | 1.195 |
| Example 3 | 15% | Periodically | 20 | 0.1% | 2856 | 1.199 |
| | | changing in | | | | |
| | | center | | | | |
| Example 4 | 20% | Center | 30 | 0.4% | 2850 | 1.199 |
| Example 5 | 3% | Center | 40 | 0.8% | 2790 | 1.193 |
| Comparative | NA | — | 60 | 1.6% | 2760 | 1.19 |
| Example 1 | | | | | | |
| Comparative | 5% | Outside of | Not | 1.2% | 2790 | 1.194 |
| Example 2 | | single side | observed | | | |
| | | winding | | | | |
| | | direction | | | | |

As can be seen from Table 1, the maximum depth of the cracks was smaller in Examples 1 to 5 than in Comparative Example 1, and therefore the rate of occurrence of internal short circuits was reduced. More particularly, as the thickness of the metal-rich layer 3 increases, the rate of occurrence of internal short circuits tends to decrease since the occurrence of cracks is suppressed. In addition, by periodically changing the position of the metal-rich layer 3 in the thickness direction, the maximum depth of the cracks was reduced significantly, and therefore the rate of occurrence of internal short circuits was reduced drastically.

In the electrode of Comparative Example 2, no cracks were observed. However, the rate of occurrence of internal short-circuits was higher than that of each Example. Observation of the internally short circuited portions showed that the internal short circuits occurred in areas at which the three-dimensional metal porous body 1 is exposed. Therefore, it is highly probable that the discontinuous metal skeleton in the metal-rich layer 3 protruded from the surface of the electrode at the time of winding, broke the separator, and came into contact with the negative electrode.

The results of the measurement of the discharge capacity and the average discharge voltage characteristics show that the discharge characteristics were better in Examples 1 to 5 than in Comparative Example 1. This is due to the presence or absence of the metal-rich layer 3. More particularly, as the thickness of the metal-rich layer 3 increases, the discharge characteristics tend to improve. Moreover, by periodically changing the position of the metal-rich layer 3 in the thickness direction, the discharge characteristics were further improved even when the thicknesses of the metal-rich layers 3 were the same. This may be because the current collecting characteristics were improved by suppressing the occurrence of cracks.

However, in Example 5 in which the ratio of the thickness of the metal-rich layer 3 to the thickness of the electrode was 3%, the above effect was slightly reduced since the relative thickness of the metal-rich layer 3 was small. In contrast, in Example 4 in which this ratio was 20%, the depth of cracks and the rate of occurrence of internal short circuits were worse than those in Example 1 in which the ratio was 15%. This may be because of the following. To ensure the capacity of the battery, the ratio of the thickness of the metal-rich layer 3 must be increased while the areal metal weight of the three-dimensional metal porous body 1 is held constant. To satisfy this condition, the thickness of the three-dimensional metal porous body 1 is first increased, and the active material 2 is charged thereinto. Therefore, the thickness of the metal skeleton in the charged portions is reduced, and cracks are generated during winging. This causes an internal short circuit to occur. In Example 4 in which the ratio was 20%, it is considered that the adverse effects of the reduction in thickness of the metal skeleton are present. Therefore, the ratio of the thickness of the metal-rich layer 3 to the thickness of the electrode is preferably 5 to 15%.

### INDUSTRIAL APPLICABILITY

The rechargeable battery produced using the rechargeable battery electrode of the present invention is excellent in both discharge characteristics and short circuit resistance. Therefore, the rechargeable battery is suitable for tough-use applications such as auxiliary power sources of hybrid electric vehicles and power sources of power tools and therefore has high applicability.

1. An electrode for a rechargeable battery, comprising a three-dimensional metal porous body (1) and an active material (2) charged into voids in the three-dimensional metal porous body (1), wherein
the three-dimensional metal porous body includes a metal-rich layer (3) having a metal density greater than that of the rest of the three-dimensional metal porous body, the metal-rich layer (3) being provided in a region except for a thicknesswise surface layer portion of the three-dimensional metal porous body.

2. The electrode for a rechargeable battery according to claim 1, wherein a ratio of a thickness of the metal-rich layer (3) to a thickness of the electrode is 5 to 15%.

3. The electrode for a rechargeable battery according to claim 1, wherein a position of the metal-rich layer (3) is periodically changed in a thickness direction of the electrode.

4. A method for manufacturing a rechargeable battery electrode in which a paste (5) containing an active material (2) as a main component is charged into voids in a strip-like three-dimensional metal porous body (1) while the three-dimensional metal porous body (1) is moved, the method comprising:
a first step of producing an electrode precursor (6) by ejecting the paste from a pair of paste-ejecting nozzles (4) disposed so as to face opposite surfaces of the three-dimensional metal porous body, the paste being ejected such that a portion unfilled with the paste is left inside the three-dimensional metal porous body;
a second step of drying the electrode precursor; and
a third step of rolling the dried electrode precursor.

5. The method for manufacturing a rechargeable battery electrode according to claim 4, wherein, while a total amount of the paste (5) ejected from the pair of paste-ejecting nozzles (4) is maintained substantially constant in the first step, an amount of the paste ejected from one of the paste-ejecting nozzles and an amount of the paste ejected from the other paste-ejecting nozzle are periodically changed.
